(19) United States
(12) Patent Application Publication
(10) Pub. No.: US 2019/0108437 A1
(43) Pub. Date: Apr. 11, 2019

(54) TWO AND THREE-DIMENSIONAL NEURAL NETWORK ARRAYS

(71) Applicants: Fu-Chang Hsu, San Jose, CA (US); Kevin Hsu, San Jose, CA (US)

(72) Inventors: Fu-Chang Hsu, San Jose, CA (US); Kevin Hsu, San Jose, CA (US)

(21) Appl. No.: 16/006,730

(22) Filed: Jun. 12, 2018

Related U.S. Application Data
(60) Provisional application No. 62/570,518, filed on Oct. 10, 2017.
(60) Provisional application No. 62/572,411, filed on Oct. 13, 2017.
(60) Provisional application No. 62/574,895, filed on Oct. 20, 2017.
(60) Provisional application No. 62/577,171, filed on Oct. 26, 2017.
(60) Provisional application No. 62/617,173, filed on Jan. 12, 2018.
(60) Provisional application No. 62/619,800, filed on Jan. 20, 2018.
(60) Provisional application No. 62/622,425, filed on Jan. 26, 2018.
(60) Provisional application No. 62/624,800, filed on Jan. 31, 2018.

(51) Int. Cl. G06N 3/063; G06N 3/04

(52) U.S. Cl. CPC G06N 3/0635; G06N 3/04

(57) ABSTRACT

Two and three-dimensional neural network arrays. In an exemplary embodiment, a two-dimensional (2D) neural network array includes a plurality of input neurons connected to a plurality of input lines, and a plurality of output neurons connected to a plurality of output lines. The 2D neural network array also includes synapse elements connected between the input lines and the output lines. Each synapse element includes a programmable resistive element. A three-dimensional (3D) neural network array includes a plurality of stacked two-dimensional (2D) neural network arrays each having a plurality of input neurons connected to a plurality of input layers and a plurality of output neurons connected to a plurality of output layers. The output layers intersect with the input layers and include synapse elements formed between intersecting regions of the input layers and the output layers. Each synapse element includes a programmable resistive element.

### CLAIM TO PRIORITY

This application claims the benefit of priority based upon U.S. Provisional Patent Application having Application No. 62/624,800, filed on Jan. 31, 2018, and entitled “2D AND 3D NEURAL NETWORK ARRAY” and U.S. Provisional Patent Application having Application No. 62/619,800, filed on Jan. 20, 2018, and entitled “3D NEURAL NETWORK ARRAY” and U.S. Provisional Patent Application having Application No. 62/622,425, filed on Jan. 26, 2018, and entitled “HIGHLY CONFIGURABLE 3D NEURAL NETWORK ARRAY” and U.S. Provisional Patent Application having Application No. 62/570,518, filed on Oct. 10, 2017, and entitled “3D Neural Network Array” and U.S. Provisional Patent Application having Application No. 62/572,411, filed on Oct. 13, 2017, and entitled “3D Neural Network Array” and U.S. Provisional Patent Application having Application No. 62/574,895, filed on Oct. 20, 2017, and entitled “3D Neural Network Array” and U.S. Provisional Patent Application having Application No. 62/577,171, filed on Oct. 26, 2017, and entitled “Neural Network Training Algorithm” and U.S. Provisional Patent Application having Application No. 62/617,173, filed on Jan. 12, 2018, and entitled “3D Neural Network Array” all of which are hereby incorporated herein by reference in their entireties.

### FIELD OF THE INVENTION

The exemplary embodiments of the present invention relate generally to the field of neural networks, and more specifically to the design and operation of neural network arrays.

### BACKGROUND OF THE INVENTION

A neural network is an artificial intelligence (AI) system that has learning capabilities. AI systems have been used for may applications such as voice recognition, pattern recognition, and hand-writing recognition to name a few.

The typical neural network having neurons connected by synapses may be implemented by using software or hardware. A software implementation of a neutral network relies on a high-performance CPU to execute specific algorithms. For very high density neural networks, the speed of the CPU may become a bottleneck to the performance of real-time tasks. On the other hand, a hardware implementation typically results in circuit sizes that may limit the density or size of the neural network thereby limiting its functionality.

Therefore, it is desirable to have a neural network array that overcomes the problems of conventional arrays.

### SUMMARY

Two-dimensional (2D) and three-dimensional (3D) neural network arrays are disclosed. In various exemplary embodiments, a 2D neural network array includes a plurality of input and output neurons formed using one or more transistors. The transistors may be NMOS or PMOS, planar or vertical, junction or junction-less device, enhancement, native, or depletion devices. In an exemplary embodiment, the transistors perform a neuron threshold function. The novel neural network arrays disclosed result in very small neurons and overall circuit size. The results are fast, high density configurable neural network arrays.

In an exemplary embodiment, a two-dimensional (2D) neural network array is provided that comprises a plurality of input neurons connected to a plurality of input lines, and a plurality of output neurons connected to a plurality of output lines. The 2D array also comprises synapse elements connected between the input lines and the output lines. Each synapse element includes a programmable resistive element.

In an exemplary embodiment, a two-dimensional (2D) neural network array is provided that comprises a plurality of output line layers orientated in a first direction, a plurality of output neurons connected to the output line layers, respectively, a plurality of input line layers orientation in a second direction and overlapping the output line layers, and a plurality of input neurons connected to the input line layers, respectively. The 2D array also comprises a plurality of synapse elements formed between intersecting portions of the output line layers and the input line layers. Each synapse element includes a programmable resistive element.

In an exemplary embodiment, a three-dimensional (3D) neural network array is provided that comprises a plurality of stacked two-dimensional (2D) neural network arrays. Each 2D neural network array comprises a plurality of input neurons connected to a plurality of input layers, a plurality of output neurons connected to a plurality of output layers. The output layers intersect with the input layers. The 3D array also comprises synapse elements formed between intersections of the input layers and the output layers. Each synapse element includes a programmable resistive element.

Additional features and benefits of the exemplary embodiments of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 shows an exemplary embodiment of a 2D neural network array constructed in accordance with the invention;

FIGS. 2A-C show exemplary embodiments of synapse devices suitable for use in the array shown in FIG. 1;

FIG. 3 shows an exemplary embodiment of a 2D multiple-layer neural network array constructed using the array structure shown in FIG. 1

FIGS. 4A-J show detailed exemplary embodiments of 2D neural network layer structures;

FIG. 5A shows another detailed exemplary embodiment of a 2D neural network array;

FIG. 5B shows another detailed exemplary embodiment of a 2D neural network array;

FIG. 6A shows an exemplary embodiment of a 2D neural network array based on the implementations shown in FIG. 1 and FIG. 3;

FIG. 6B shows an exemplary embodiment of a 2D neural network array having four network layers;

FIG. 7A shows an exemplary embodiment of 3D neural network array structure that comprises multiple 2D neural network layers;

FIG. 7B shows an exemplary embodiment of a multiple-layer neural network circuit representing the array structure shown in FIG. 7A;

FIGS. 7C-D show exemplary cross-section views of the 3D neural network array shown in FIG. 7B taken along the X and Y directions, respectively;

FIG. 8A shows another exemplary embodiment of 3D neural network array structure that comprises multiple 2D neural network layers;

FIG. 8B shows an exemplary embodiment of a multiple-layer neural network circuit representing the array structure shown in FIG. 8A;

FIG. 9A shows an exemplary embodiment of a 3D neural network array structure that comprises multiple 2D neural network layers;

FIG. 9B shows another exemplary embodiment of 3D neural network array structure that comprises multiple 2D neural network layers; and

FIG. 9C shows an exemplary embodiment of a multiple-layer neural network circuit representing the array structures shown in FIGS. 9A-B.

### DETAILED DESCRIPTION

Those of ordinary skilled in the art will realize that the following detailed description is illustrative only and is not intended to be in any way limiting. Other embodiments of the present invention will readily suggest themselves to skilled persons having the benefit of this disclosure. Reference will now be made in detail to implementations of the exemplary embodiments of the present invention as illustrated in the accompanying drawings. The same reference indicators or numbers will be used throughout the drawings and the following detailed description to refer to the same or like parts.

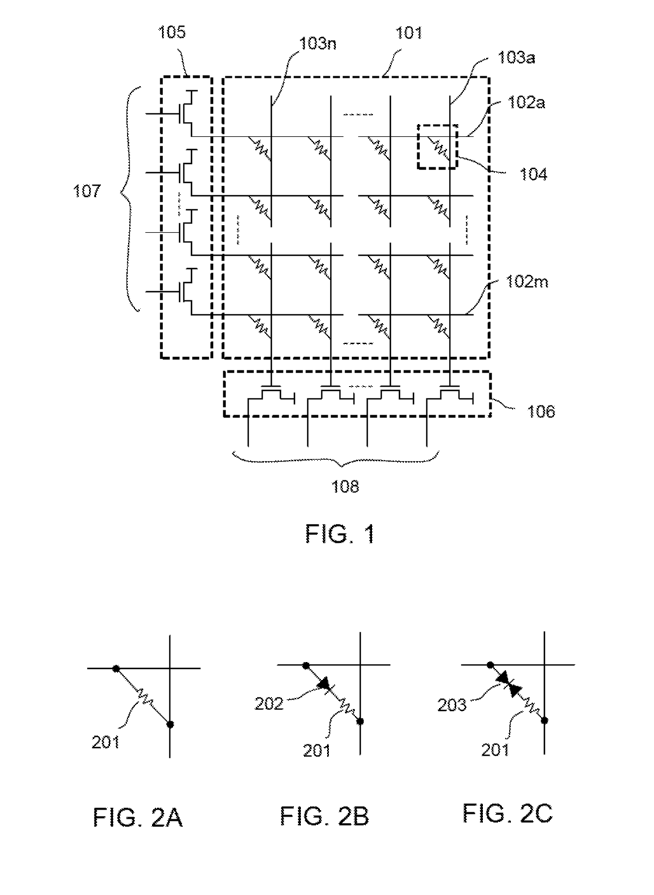

FIG. 1 shows an exemplary embodiment of a 2D neural network array constructed in accordance with the invention. The array comprises an array of synapse lines 101 that include multiple input lines, such as input lines 102a-m, and multiple output lines, such as output lines 103a-n. In exemplary embodiments, the array 101 may be referred to as an array layer, 2D array layer, network layer or 2D network layer. Thus, the output neurons of one layer form the input neurons of the adjacent or next layer. The intersection of the input lines 102 and output lines 103 include synapse devices, such as programmable device 104. In various exemplary embodiments, the device 104 is a resistive element that comprises a material such as HfOx, TaOx, PtOx, TiOx, or phase-change element, ferroelectric material, magnetic material, or another suitable programmable element.

The input lines 102a-m are connected to the input neurons 105, which may also represent output neurons of a previous array layer. For example, the inputs 107 may be connected to the previous array layer's output lines. The output lines 103a-n are connected to the output neurons 106, which may also represent the input neurons of a next array layer. For example, the outputs 108 may be connected to the next array layer's input lines. In an exemplary 2D implementation, multiple array layers can be formed side-by-side so that outputs (e.g., outputs 108) from output neurons of one layer connect to the input lines (e.g., input lines 102a-m) of an adjacent or next layer.

In various exemplary embodiments, the neurons 105 and 106 are formed by transistors. For example, each neuron is formed by one or more transistors. The transistors may be NMOS or PMOS, planar or vertical, junction or junction-less device, enhancement, native, or depletion devices. In an exemplary embodiment, the transistors perform a neuron threshold function. The novel 2D neural network array structure shown in FIG. 1 results in very small neurons and circuit size. It should also be noted that in addition to the transistors, other devices may be added to the neuron circuits within the scope of the exemplary embodiments.

FIGS. 2A-C show exemplary embodiments of synapse devices suitable for use in the array shown in FIG. 1. In FIG. 2A, the synapse device comprises a fixed or programmable resistive element 201. In FIG. 2B, the synapse device comprises the resistive element 201 and a selector 202. In FIG. 2C, the synapse device comprises the resistive element 201 and a selector 203. In various exemplary embodiments, the selector comprises a threshold device such as a diode, Schottky diode, or other threshold-behavior materials such as NbOx material, TaOx material or VCrOx material. The diode may be unidirectional or bi-directional. The selector performs unidirectional 202 or bidirectional 203 threshold functions, as shown in FIG. 2B and FIG. 2C, respectively.

When only a partial number of input lines and output lines are selected for use, the selectors prevent sneak leakage currents from flowing through the unselected input lines and output lines. For simplicity, the following figures will only show the synapse embodiment of FIG. 2A, however, the embodiments shown in FIG. 2B and FIG. 2C may be used in some or all embodiments as well.

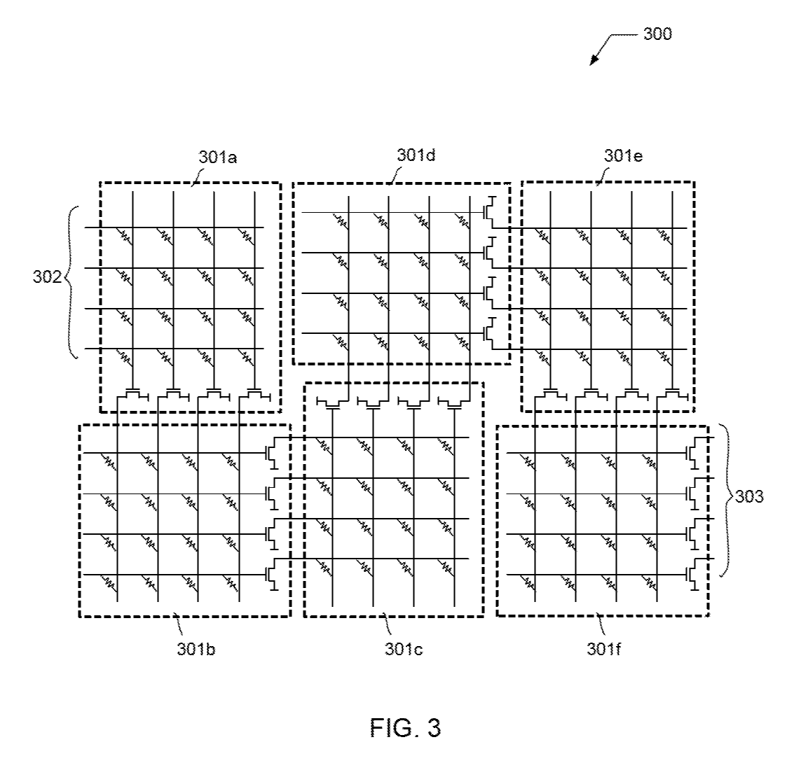

FIG. 3 shows an exemplary embodiment of a 2D multiple-layer neural network array 300 constructed using the array structure shown in FIG. 1. The array 300 comprises a first network layer 301a, a second network layer 301b, a third network layer 301c, a fourth network layer 301d, a fifth network layer 301e, and a sixth network layer 301f. The network layers are interconnected so that inputs 302 are received at network layer 301a and the outputs 303 are output from network layer 301f. Thus, the outputs neurons of layer 301a form the input neurons of layer 301b and so on. Thus, the network signals flow from network layer to network layer from the inputs 302 to the outputs 303. As illustrated in FIG. 3, the disclosed neuron and array structure results in very compact neuron and array sizes.

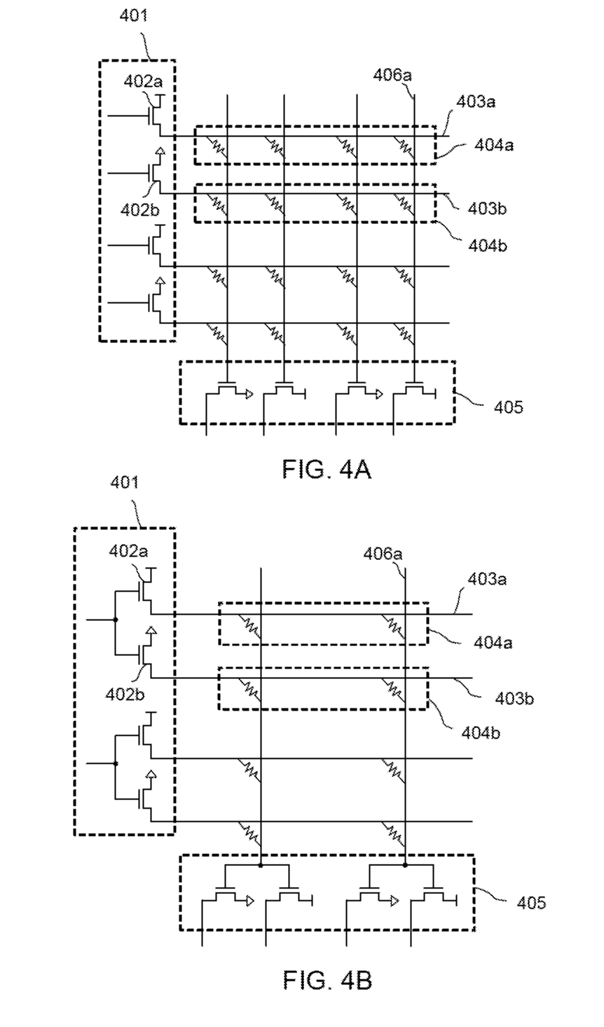

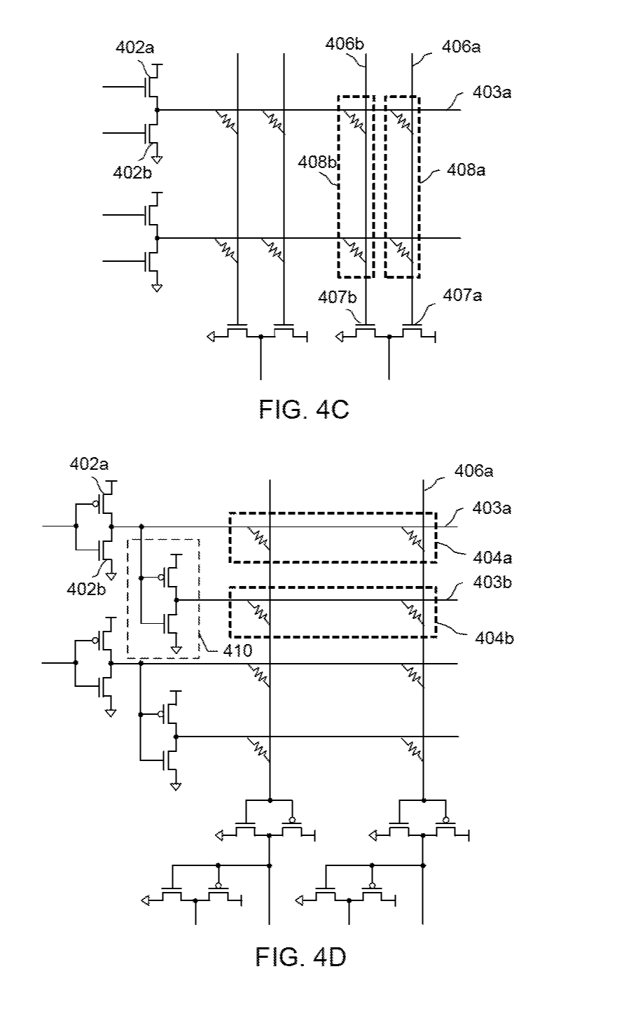

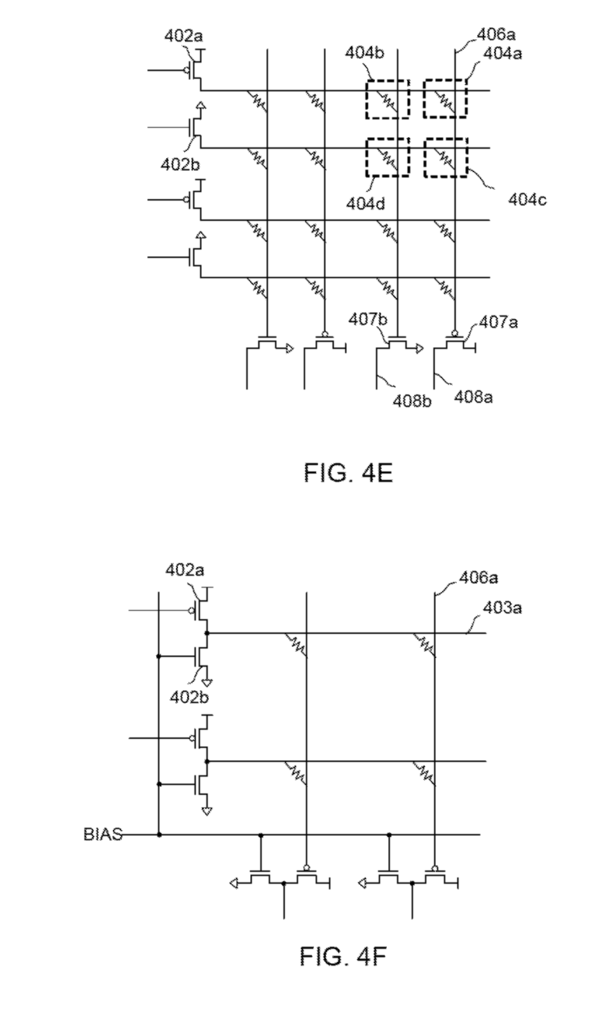

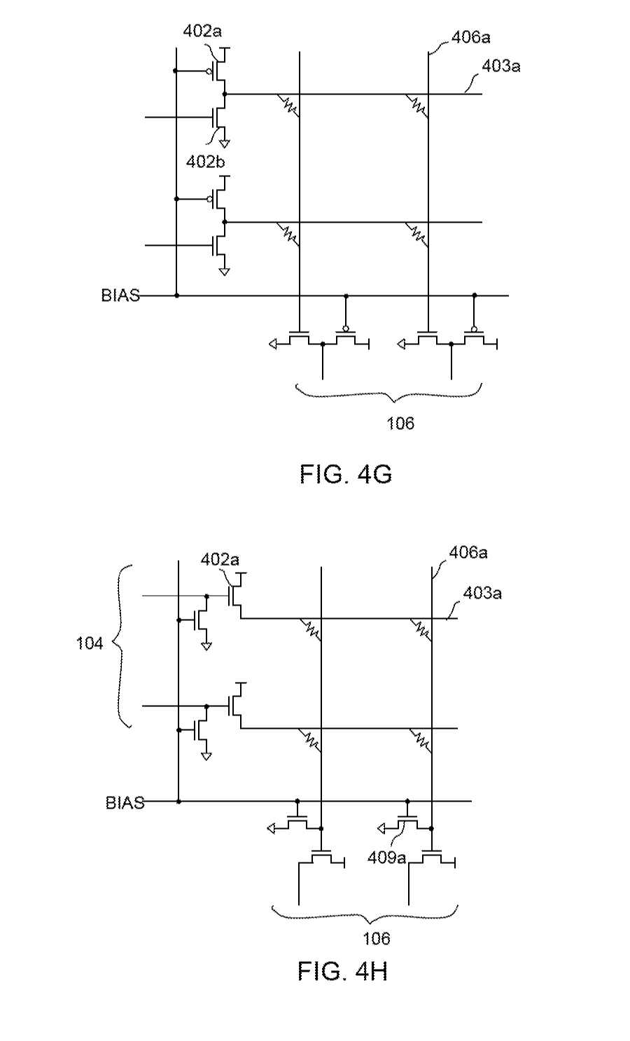

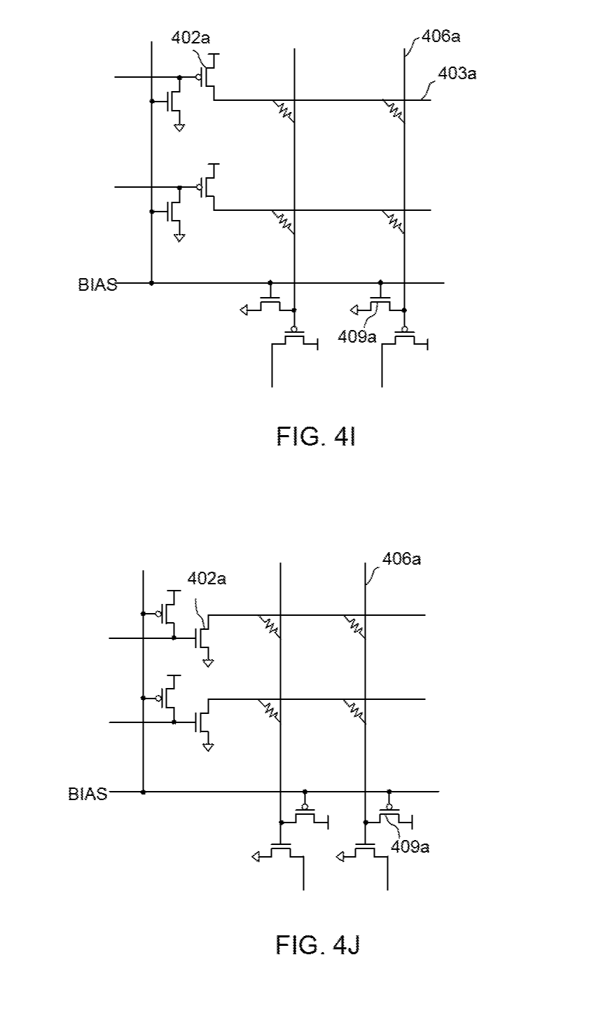

FIGS. 4A-J show detailed exemplary embodiments of 2D neural network layers for use in 2D neural network array structures.

FIG. 4A shows a detailed exemplary embodiment of a 2D neural network layer. To simplify this description, input neurons 401 and output neurons 405 are shown in all embodiments illustrated in FIGS. 4A-J. In FIG. 4A, the input neurons 401 include neuron 402a and neuron 402b. In this embodiment, the input 401 and output 405 neurons comprise NMOS transistors. A source terminal of neuron 402a is connected to VDD and a source terminal of neuron 402b is connected to VSS (GND). As the input voltage level of the neuron 402a increases, the voltage level of the input line 403a increases. Therefore, because the voltage level of the input line 403a increases with increasing input voltage to the neuron 402a, the synapses 404a represent ‘positive weights’. However, as the input voltage level to the neuron 402b increases, the voltage level of the input line 403b decreases. Therefore, because the voltage level of the input line 403b decreases with increasing input voltage to the neuron 402b, the synapses 404b represent ‘negative weights’. It should also be noted that the output neurons 405 comprises transistors with source terminals connected to either VDD or VSS.

It should be noted that when passing high voltage, (e.g., a high voltage on output line 406a) the NMOS transistors may produce a threshold voltage (Vt) drop that may cause the voltage levels passed from network layer to network layer to become lower and lower. In exemplary embodiments, the NMOS transistors may comprise native devices, low Vt devices, or depletion devices to mitigate or eliminate the Vt effect that produces decreasing voltage levels passed from network layer to network layer. In this way, the input levels provided to each layer may have the full VDD range. This approach may be applied to virtually all embodiments of the invention.

In another exemplary embodiment, the neurons in 401 and 405 comprise PMOS transistors. This results in an ‘inverse’ output. That means, when the input voltage of an input neuron increases, the corresponding input line's voltage decreases and vice versa. Therefore, the function of the synapses 404a and 404b are reversed to comprise negative and positive weights, respectively. Similarly, for all the embodiments showing NMOS or PMOS transistors, the transistors may be replaced by the complementary type of transistors, and this applies to virtually all embodiments of the invention. Thus, the neurons can be implemented with NMOS or PMOS devices and the array will achieve substantially the same result.

FIG. 4B shows another detailed exemplary embodiment of a 2D neural network layer. This embodiment is similar to the embodiment shown in FIG. 4A, except that the input neurons, such as neurons 402a and 402b are connected to receive the same input voltage level. When the input voltage level increases, the voltages of the input lines 403a and 403b become higher and lower, respectively. Therefore, the voltages of the output lines (e.g., output line 406a) depends on the ratio between the positive weights 404a and negative weights 404b. Similar to the embodiment shown in FIG. 4A, the input neurons may comprise PMOS transistors. When a PMOS transistor passes low voltage, it may produce a Vt drop. Therefore, in exemplary embodiments, the PMOS transistors may comprise native devices, low Vt devices, or depletion devices to reduce or eliminate the Vt drop.

FIG. 4C shows another detailed exemplary embodiment of a 2D neural network layer. This embodiment is similar to the embodiment shown in FIG. 4A, except that the neurons 402a and 402b are connected to the same input line 403a. Therefore, the voltage of the input line 403a depends on the ratio of the drive current between the input neurons 402a and 402b. The output lines 406a and 406b are connected to the output neurons 407a and 407b, respectively. When the voltage of the output lines 406a and 406b become higher, the voltage output of the output neurons 407a and 407b is based on the ratio of their drive currents. Therefore, the synapses 408a and 408b are said to represent positive and negative weights, respectively.

FIG. 4D shows another detailed exemplary embodiment of a 2D neural network layer. In this embodiment, the input neuron 402a is an PMOS device and the neuron 402b is a NMOS device. The inputs and outputs of the input neurons 402a and 402b are tied together. An inverter 410 is connected between the input line 403a and the input line 403b. When the voltage level of the input to the neurons 402a and 402b becomes higher, the voltages on the input lines 403a and 403b become lower and higher, respectively. Therefore, the synapses 404a and 404b represent negative and positive weights, respectively.

FIG. 4E shows another detailed exemplary embodiment of a 2D neural network layer. In this embodiment, the transistors 402a and 402b (input neurons) and transistors 407a and 407b (output neurons) are PMOS and NMOS transistors, respectively. The outputs 408a and 408b may be pull to full VDD and VSS, for example, by using enhancement devices. When the input voltage of 402a becomes higher, the output lines 408a and 408b become higher and lower, respectively. Therefore, the synapses 404a and 404b are positive and negative weights, respectively. Similarly, the synapses 404c and 404d are negative and positive weights, respectively.

FIG. 4F shows another detailed exemplary embodiment of a 2D neural network layer. In this embodiment, the neuron 402a is a PMOS device and the neuron 402b is an NMOS device and connected to a BIAS voltage. This causes the neuron 402b to acts as a weak pull-down device. Therefore, when the input of the PMOS device 402a is high, the NMOS device 402b may pull the input line 403a to 0V (VSS).

FIG. 4G shows another detailed exemplary embodiment of a 2D neural network layer. This embodiment is similar to the embodiment shown in FIG. 4F except that the BIAS voltage is applied to the PMOS device 402a. This makes the device 402a a weak pull-up device. Therefore, when the input of the NMOS device 402b is low, the PMOS device 402a may pull the input line 403a to VDD.

FIG. 4H shows another detailed exemplary embodiment of a 2D neural network layer. In this embodiment, the device 402a is a pull-up device and the device 409a is a weak pull-down device. When the input voltage of the device 402a is low, the output line 406a may be pull down to 0V (VSS) by the NMOS device 409a.

FIG. 4I shows another detailed exemplary embodiment of a 2D neural network layer. This embodiment is similar to the embodiment shown in FIG. 4H except that the input neuron 402a is replaced by a PMOS transistor to pull the input line 403a to full VDD.

FIG. 4J shows another detailed exemplary embodiment of a 2D neural network layer. This embodiment is similar to the embodiment shown in FIG. 4I except that the input neuron 402a is a pull-down device and device 4029a is a pull-up device. Therefore, when the input voltage of the device 402a is low, the pull-up device 409a will pull the output line 406a to VDD.

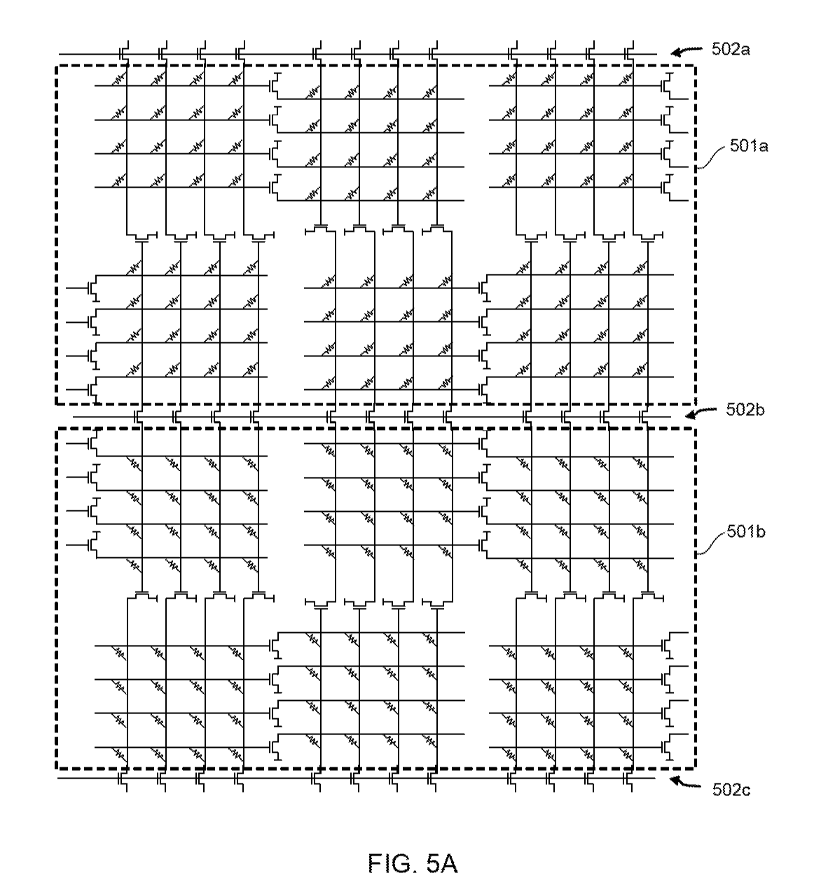

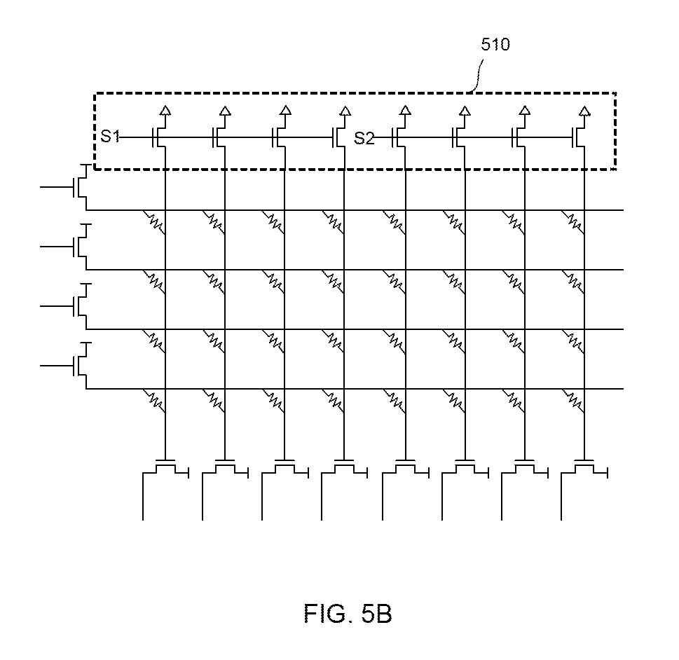

FIG. 5A shows a detailed exemplary embodiment of a 2D neural network array. This embodiment includes pass gates 502a-c. In an exemplary embodiment, the pass gates 502a-c are NMOS transistors, however, any other suitable devices may be utilized. The pass gates 502a-c are added in between neural network array portions 501a and 501b. This provides flexibility for configuring the neuron number for each layer or the overall array size. For example, when the pass gates 502b are turned off, the array portions 501a and 501b are disconnected and form two separated neural network arrays. By turning on the pass gates 502b, the array portions 501a and 501b are connected and merge into one neural network array. The pass gates 502a and 502c can be used to control whether or not the array portions 501a and 501b are connected to other network layers (not shown).

FIG. 5B shows another detailed exemplary embodiment of a 2D neural network array. In this embodiment, pull-down devices 510 are added to each output line. The pull-down devices are divided into two groups that are enabled or disabled by control signals S1 and S2. The grouping of the pull-down devices and the number of control signals can be freely configured to allow the number of output neurons to be freely configured. For example, if S1 is set to disable the pull-downs in its group and S2 is set to enable the pull-downs in its group, the array will be configured to have only four active output neurons that correspond to the S1 group. The gates of the un-used output neurons are pulled low by the S2 group to turn off those output neurons.

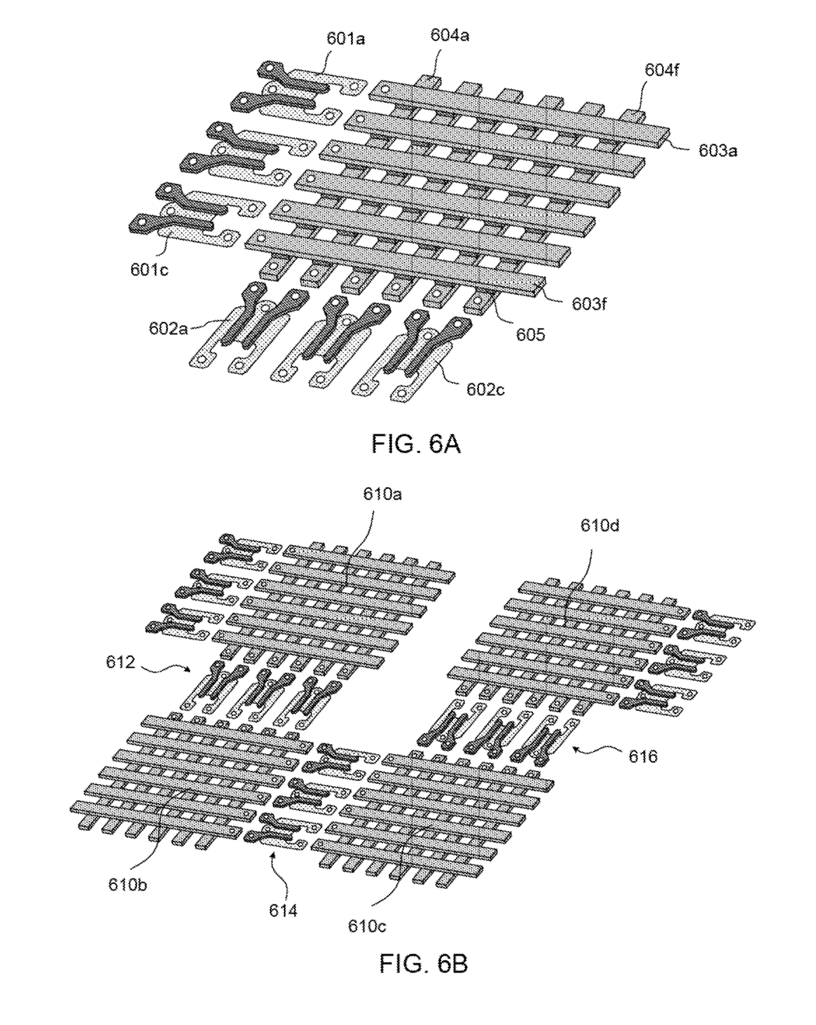

FIG. 6A shows an exemplary embodiment of a 2D neural network array structure based on the implementations shown in FIG. 1 and FIG. 3. In this embodiment, the 2D array comprises input neurons 601a-c, output neurons 602a-c. The array also comprises input line layers 603a-f in a first orientation and overlapping output line layers 604a-f in a second orientation. Between the input line layers 603 and the output line layers 604 are formed synapses, such as the synapse 605. The input neurons 601 and the output neurons 602 have corresponding connections (not shown) to the input line layers 603 and the output line layers 604. It should be noted that although the array shown in FIG. 6A has more than one layer it is generally referred to as a “2D” neural network array structure.

FIG. 6B shows an exemplary embodiment of a 2D neural network array having four network layers. For example, each network layer of the 2D neural network is configured as the neural network layer as shown in FIG. 3. For example, the array shown in FIG. 6B comprises neural network layers 610a-d in which outputs of one layer are connected to inputs of an adjacent layer. It should be noted that the neurons 612, 614, and 616 act as both input and output neurons.

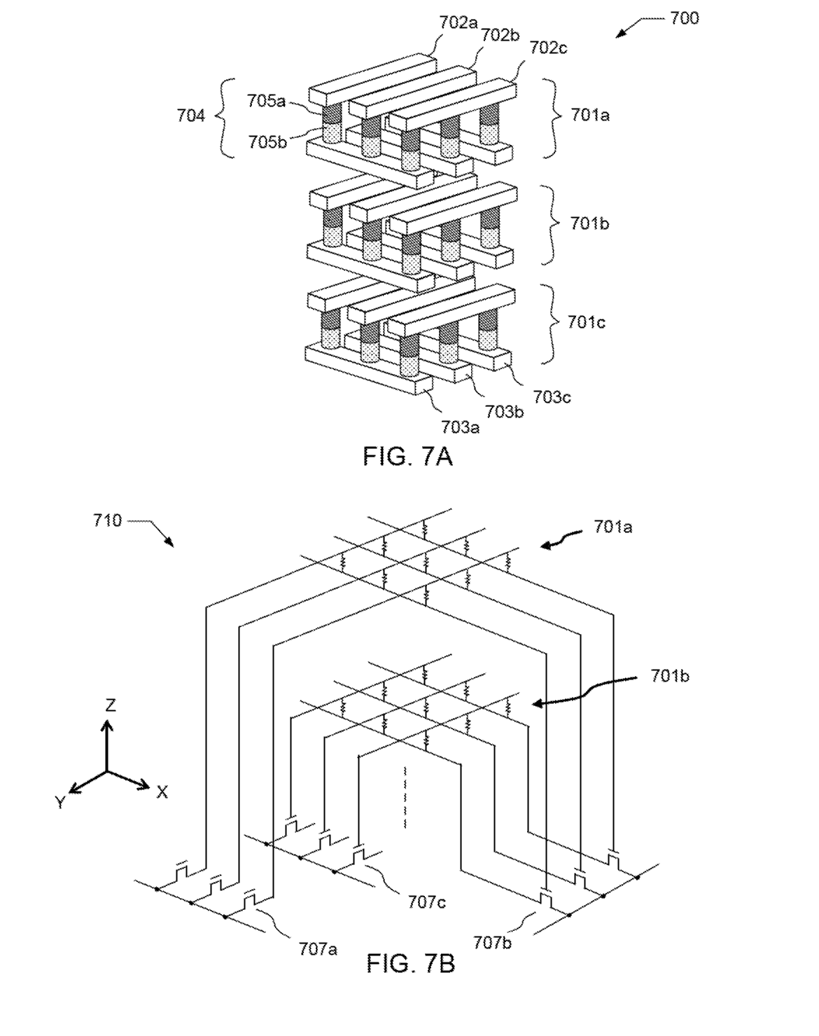

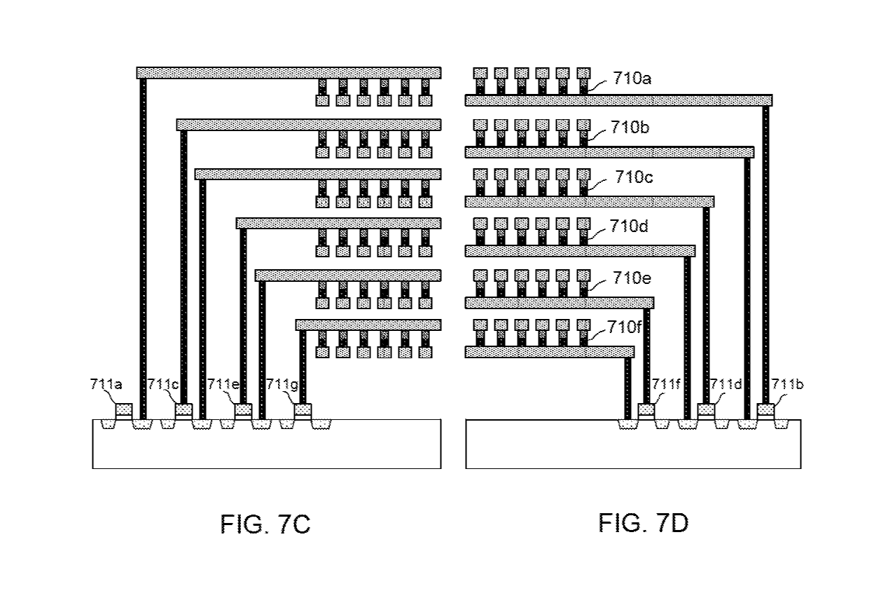

It should be understood that the disclosed 2D neural network array architecture can also be used to form 3D array structures. FIG. 7A to FIG. 9C shows some exemplary embodiments of 3D neural network architectures that can be formed from embodiments of the 2D neural network arrays shown above.

FIG. 7A shows an exemplary embodiment of a 3D neural network array structure 700 that comprises multiple layers of a 2D neural network structure. For example, the array 700 comprises 2D neural network layers 701a to 701c. For example, each 2D network layer operates as the network layer 101 shown in FIG. 1. The array 701a comprises input lines 702a to 702c and output lines 703a to 703c. The array 701a also includes synapse devices, such as the synapse device 704. In an exemplary embodiment, the synapse device 704 comprises a resistive element 705a and a selector 705b.

FIG. 7B shows an exemplary embodiment of a multiple-layer neural network circuit 710 formed by the array structure 700 shown in FIG. 7A. For clarity, not all network layers shown in FIG. 7A are depicted in FIG. 7B. The array 710 comprises the first layer 701a and the second layer 701b. Additional layers are not shown. Coupled to the array are neurons 707a, 707b, and 707c.

FIGS. 7C-D show exemplary cross-section views of the 3D neural network array 710 taken along the X and Y directions, respectively. Layers 710a-f are the first to sixth layers of neural network, respectively. Also shown are the input neurons 711a-f of the first to seventh layers, respectively.

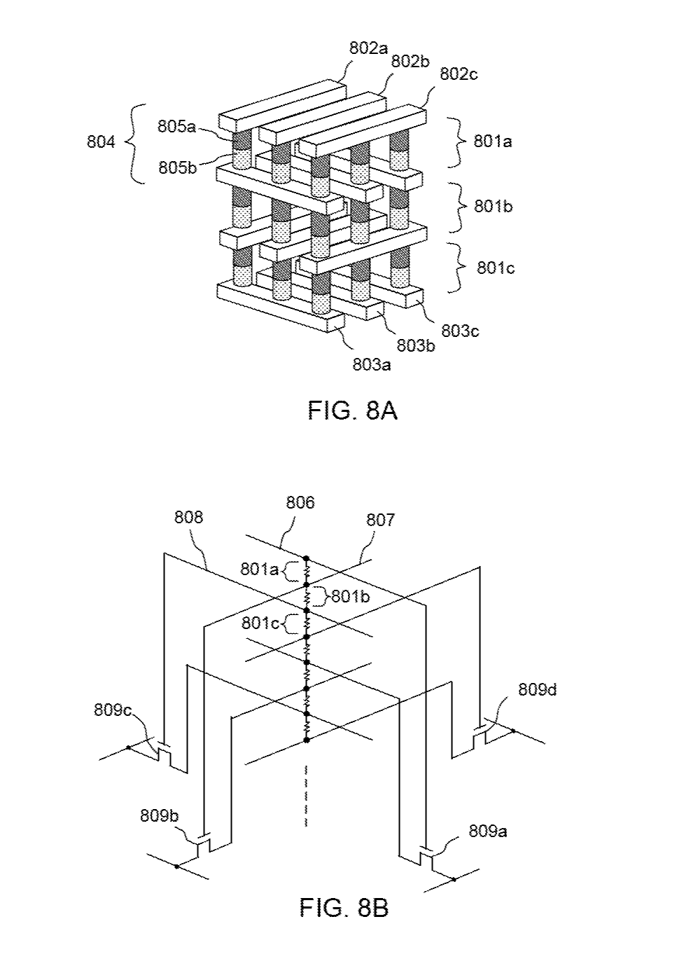

FIG. 8A shows another embodiment of 3D neural network array structure. This embodiment is similar to FIG. 7A except that there is no separation between layers.

FIG. 8B shows an embodiment of the multiple-layer neural network circuit formed by the 3D array structure shown in FIG. 8A. For clarity, only a simplified circuit is shown in FIG. 8B. The network circuit comprises the first to third layers 801a-c. Also shown are input and output lines 806, 807, 808 and neurons 809a-d.

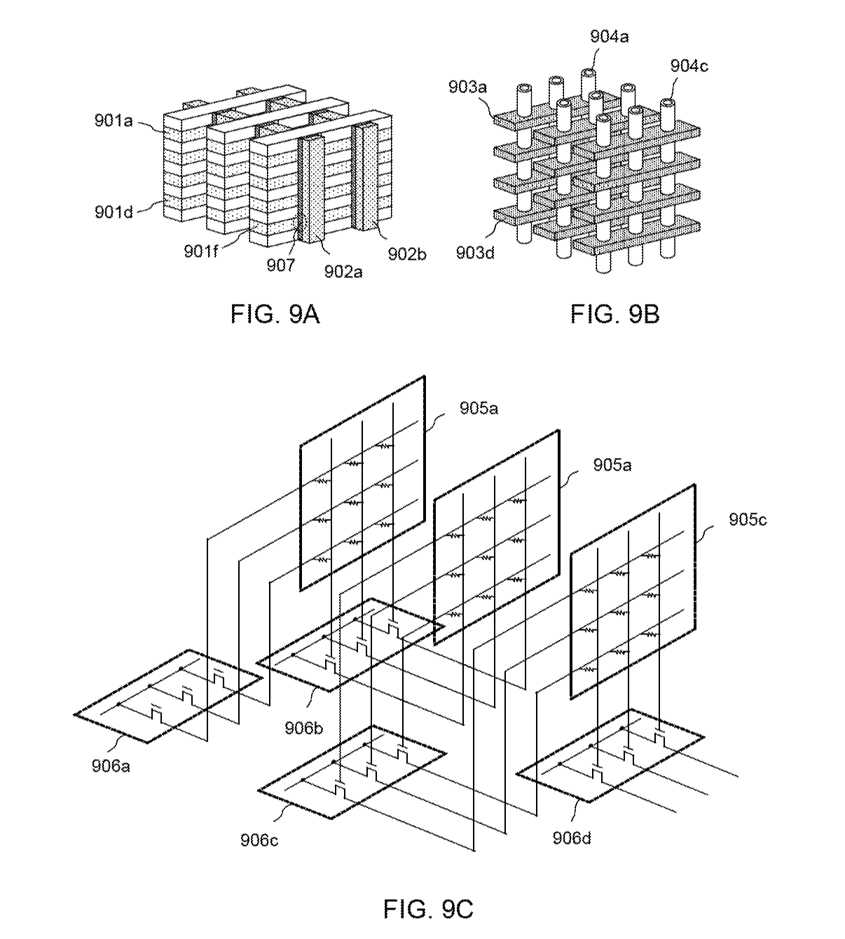

FIG. 9A shows another exemplary embodiment of a 3D neural network array structure constructed using 2D neural network structures described herein. The structure shown in FIG. 9A comprises horizontal input line layers 901a-d separated by isolation layers. Also shown are vertical output line layers 902a-b. Synapses are formed between the input and output line layers and shown in dark shading. For example, the synapse 907 in the dashed region is formed between the input line layer 901f and the output line layer 902a. Thus, the 3D array structure comprises three 2D neural network layers in a vertical orientation. In an alternative embodiment, the inputs and outputs may be exchanged.

FIG. 9B shows another exemplary embodiment of 3D neural network array structure constructed using the 2D neural network structures disclosed herein. In this embodiment, the vertical line layers 904a-c are trenched through the horizontal line layers 903a-d.

FIG. 9C shows an exemplary embodiment of a multiple-layer neural network circuit formed by the array structures in FIG. 9A-B. This embodiment comprises first to third layers 905a-c and neurons 906a-d.

While exemplary embodiments of the present invention have been shown and described, it will be obvious to those with ordinary skills in the art that based upon the teachings herein, changes and modifications may be made without departing from the exemplary embodiments and their broader aspects. Therefore, the appended claims are intended to encompass within their scope all such changes and modifications as are within the true spirit and scope of the exemplary embodiments of the present invention.

What is claimed is:

1. A two-dimensional (2D) neural network array, comprising:
a plurality of input neurons connected to a plurality of input lines;
a plurality of output neurons connected to a plurality of output lines; and
synapse elements connected between the input lines and the output lines, and wherein each synapse element includes a programmable resistive element.

2. The 2D neural network of claim 1, wherein each of the input and output neurons comprise at least one transistor.

3. The 2D neural network of claim 2, wherein the at least one transistor comprises one of an NMOS or PMOS transistor.

4. The 2D neural network of claim 1, wherein each of the input and output neurons comprise one transistor.

5. The 2D neural network of claim 1, wherein each programmable resistive element comprises material selected from a set of materials comprising resistive material, phase change material, ferroelectric material, and magnetic material.

6. The 2D neural network of claim 1, wherein at least one synapse element includes a threshold device.

7. The 2D neural network of claim 6, wherein the threshold device comprises at least one of diode material, Schottky diode material, NbOx material, TaOx material and VCrOx material.

8. The 2D neural network of claim 1, wherein a first portion of the input neurons are connected to a high voltage level (VDD) and a second portion of the input neurons are connected to a low voltage level (VSS) and a first portion of the output neurons are connected to a high voltage level (VDD) and a second portion of the output neurons are connected to a low voltage level (VSS).

9. The 2D neural network of claim 1, wherein the input neurons comprise NMOS transistors that are grouped into pairs and gate terminals of each pair of transistors are connected together and a source terminal of one transistor in each pair is connected to a high voltage level (VDD) and a source terminal of one transistor in each pair is connected to a low voltage level (VSS).

10. The 2D neural network of claim 1, wherein each input neuron comprises an NMOS transistor and a PMOS transistor having source and drain terminals connected to one input line and a drain terminal of the NMOS transistor is connected to a high voltage level (VDD) and a source terminal of the PMOS transistor is connected to a low voltage level (VSS).

11. The 2D neural network of claim 10, further comprising a plurality of inverters, each inverter having an inverter input connected to a first input line and an inverter output forming a second input line.

12. The 2D neural network of claim 1, wherein each input neuron comprises an NMOS transistor and a PMOS transistor having source and drain terminals connected to one input line and a gate terminal of the NMOS transistor is connected to a bias signal.

13. The 2D neural network of claim 1, further comprising a plurality additional 2D neural network arrays that are combined with the 2D network array to form a combined array, wherein output neurons of a selected first array form input neurons of an adjacent array.

14. The 2D neural network of claim 13, further comprising a plurality of selectors dividing the combined array into two or more portions, and wherein enabling or disabling the selectors controls an active size of the combined array.

15. The 2D neural network of claim 1, further comprising a plurality of selectors connected to the plurality of output lines, respectively, wherein enabling or disabling the selectors controls an active portion of the 2D neural network.

16. A two-dimensional (2D) neural network array, comprising:
a plurality of output line layers orientated in a first direction;
a plurality of output neurons connected to the output line layers, respectively;
a plurality of input line layers orientation in a second direction and overlapping the output line layers;
a plurality of input neurons connected to the input line layers, respectively; and
a plurality of synapse elements formed between intersecting portions of the output line layers and the input line layers, and wherein each synapse element includes a programmable resistive element.

17. The two-dimensional (2D) neural network array of claim 16, further comprising:
additional 2D neural network arrays formed in the same plane as the 2D neural network array, and wherein output neurons of a selected first array form input neurons of an adjacent array.

18. A three-dimensional (3D) neural network array, comprising:
a plurality of stacked two-dimensional (2D) neural network arrays, wherein each 2D neural network array comprises:
a plurality of input neurons connected to a plurality of input layers;
a plurality of output neurons connected to a plurality of output layers, and wherein the output layers intersect with the input layers; and
synapse elements formed between intersections of the input layers and the output layers, and wherein each synapse element includes a programmable resistive element.

19. The 3D neural network of claim 18, wherein at least one synapse element includes a threshold device.

20. The 3D neural network of claim 18, wherein output neurons of a selected layer form input neurons of an adjacent layer.
